(19) United States
(12) Patent Application Publication
(10) Pub. No.: US 2013/0255366 A1
(43) Pub. Date: Oct. 3, 2013

(54) Brake Monitoring Device And Components Associated Therewith

(71) Applicants: Fredrik Seglo, Viken (SE); Anders Larsson, Helsingborg (SE)

(72) Inventors: Fredrik Seglo, Viken (SE); Anders Larsson, Helsingborg (SE)

(21) Appl. No.: 13/902,465

(22) Filed: May 24, 2013

Related U.S. Application Data
(63) Continuation of application No. PCT/EP2010/007192, filed on Nov. 26, 2010.

(51) Int. Cl. G01L 5/28; F16P 1/00; G05G 1/04

(52) U.S. Cl. CPC G01L 5/28; G05G 1/04; F16P 1/00
USPC 73/121; 74/608; 74/519

(57) ABSTRACT

A monitoring device for detecting a value indicative of the actuation stroke and/or release stroke of a thrust element of a brake actuating mechanism, the thrust element being actuated by a lever of the brake actuating mechanism, including a sensor for sensing variations in a physical property of at least one part of the brake actuating mechanism, whereby the sensor and the part of the brake actuating mechanism are arranged so that by the relative movement between the part of the brake actuating mechanism and the sensor repeated variations in the physical property along a path of the relative movement are created and sensed. The path is formed between the lever and a stationary part being adjacent to the lever. The invention is directed both to drum brakes and to disc brakes.

### FIELD OF THE INVENTION

The present invention refers to a brake monitoring device to be employed in brake mechanisms of different kind. Further, the invention refers to a drum brake and a disc brake, respectively, which comprise such a brake monitoring device. Several components of brake actuating mechanisms, which cooperate which such a brake monitoring device, are considered by this invention as well.

### BACKGROUND OF THE INVENTION

In vehicle brakes, at least one rotor connected to a wheel is braked by friction elements to be applied to the rotor during brake actuation. In drum brakes, brake shoes are radially and tangentially moved towards the rotating drum, the brake shoes being arranged inside the drum and spread by means of a S-cam in fixed connection with a shaft, which shaft is set into rotation by a lever.

In some kind of disc brakes a brake pad at the end of at least one thrust element is pushed towards the brake disc, the thrust element being actuated by a lever.

In both brake mechanism types, the actuator could use either pneumatic, hydraulic or electric principles. The lever will be applied to the S-cam shaft of a drum brake or to the thrust element of a disc brake and causes a brake actuation stroke of these components upon brake actuation, whereby a release stroke of these components upon release of the brake in the reverse direction usually is supported by return spring mechanisms.

In drum brakes such brake actuation stroke is performed by the brake shoes radially converging towards the inner surface of the rotating brake drum and finally engaging therewith. In disc brakes the stroke is performed by the thrust element which thereby substantially axially linearly displaces towards the brake disc. In other words, the brake actuation or release stroke is performed by components of the brake actuation mechanism containing the brake lining and corresponds to the distances these components can traverse in actuation and release direction.

Accordingly, a large stroke might be indicative of some kind of malfunction of the brake mechanism. Reasons for too large stroke could result from defective automatic slack adjusters, from a too large wear of the linings of the brake pads or brake shoes or from any other reasons.

A too short stroke may appear e.g. when the actuating cylinder does not work or when the brake is not properly released due to failing return mechanism.

Therefore, for safety reasons, there is the need to monitor and detect somehow the brake actuation and/or release stroke, since an excessive stroke indicates either a breakdown of the brake actuating mechanism including the adjuster mechanism on the one hand or a need to replace the brake linings due to wear on the other, and, moreover, since a shortened stroke indicates a breakdown of either the actuating cylinder or of the return mechanism.

Currently, three different measuring principles have been used for that purpose in the state of the art.

For example, several indicators may simply provide an alarm signal to the driver or to superior control systems when the stroke exceeds a predetermined length. Such indicators are often based on switches governed by magnetic or mechanical means. Although, they prove to be rather cost effective, such monitoring devices need proper adjustment at installation and at overhaul, which in turn increases the costs.

Another principle refers to the detection of the actually existing stroke. Sensors to be used for such a quantitative detection method provide signals which reflect the linear travel (disc brakes) or angular travel (drum brakes) with good accuracy. However, such sensors prove to be too expensive when only excessive stroke shall be determined.

Examples of prior art monitoring systems of that kind can be seen from e.g. U.S. Pat. No. 5,433,296 or U.S. Pat. No. 7,398,141 B2.

A third principle refers to the measurement of the actual lining wear status of the different brake pads or shoes. Sensors for that purpose are mainly used together with sophisticated brake control systems which are applied to level out the lining wear between different brakes on the vehicle in dynamic vehicle control systems. Also, such sensors are considered to be rather too expensive for simple tasks for monitoring the stroke.

Examples of prior art monitoring systems of that kind can be seen from e.g. U.S. Pat. No. 5,339,069 or US 2009/0050418 A1 or DE 195 34 854 A1.

For most safety purposes, and sometimes even encouraged by government authorities, it is enough to monitor the brake actuation stroke with a certain approximate accuracy, which does not provide the exact actual stroke value, i.e. it may be enough to provide a qualitative rather than a quantitative indication of the actually existing stroke.

### SUMMARY OF THE INVENTION

Based on the above, it is an objective of the present invention to provide a simple brake monitoring system for a brake mechanism which brake monitoring system functions in a reliable and efficient way, which is cost effective and which is easy to mount.

Such objective is solved by a brake monitoring device according to claim 1. Furthermore, such objective is solved by a drum brake according to claim 14 and a disc brake according to claim 24, respectively. The new design of several components of brake actuating mechanisms, such as brake lever, control arm and cover, contributes to the solution of the problems.

The invention provides a brake monitoring device for detecting a value indicative of the actuation stroke and/or release stroke of a thrust element of a brake actuating mechanism, the thrust element being actuated by a lever of said brake actuating mechanism, comprising a sensor for sensing variations in a physical property of at least one part of said brake actuating mechanism, whereby the sensor and said part of the brake actuating mechanism are arranged so that by the relative movement between said part of the brake actuating mechanism and the sensor repeated variations in said physical property along a path of said relative movement are created and sensed, whereby said path is formed between, i.e. along one of the lever and a stationary part being adjacent to said lever.

Accordingly, the sensor to be used in the brake monitoring device according to the invention is configured and arranged to count the number of these repeated variations in the form of pulses within the time span for a normal brake actuation or brake release. If the number of pulses exceeds or falls below a preset number of pulses to be predefined for the respective time span, an alert signal is generated, which could be supplied either to a driver or to a superior control system.

Thus, there is no need to accurately detect the physical quantity of concern, it will be simply enough to use a sensor in the brake monitoring device according to the invention which is capable of distinguishing between two well separated quantities. Accordingly, the sensor element which is to be employed in the brake monitoring device must only have a simple sensing structure and therefore will be inexpensive.

Furthermore, one peculiar advantage of the sensing principle to be embodied by the present invention in a brake monitoring device is that it does not require any reference points, so that there is no need to properly install and adjust the sensor relative to the path of the repeated variations. Also, no electronic adjustment in the superior control system or in its software becomes necessary. By that, installations and overhauls will become easier and more cost effective. Furthermore, one possible failure mode associated with a non exact positional installation, as known from other more accurate measurement principles, can be eliminated by the system according to the present invention.

The physical property for the repeated variations can be selected from parameters such as magnetic field, electric resistance, electric capacitance, electric inductance and/or surface structure etc.

Preferably, the repeated variations are uniformly and equidistantly distributed along the path.

According to the invention, the repeated variations in surface structure comprise variations in geometry. Such variations along the path could include a series of recesses or slots or teeth. The path, depending on the place of arrangement of the brake monitoring device relative to the stationary part, could be arc-shaped or linear.

In a preferred embodiment, the component comprising the path is metallic and at least one magnet is arranged in the vicinity of the repeated variations so as to create a varying strength of a magnetic field in accordance with said repeated variations. The magnet generates a magnetic flux in the metallic material portions of the path, e.g. in the teeth (or in the sections between the slots), whereas in the recesses between the teeth (or in the slots) no magnetic flux is generated. Thus, the magnetic flux is always concentrated in the material portions of the repeated variations and the magnetic field resulting therefrom could be measured. Accordingly, a magnetic sensor then counts the variations in the magnetic field close to the path having the repeated slots or teeth.

Preferably, the magnet and the magnetic sensor are arranged inside a self-contained housing, which housing could be located relative to the path, accordingly.

Alternatively, the path could also comprise a series of permanent magnets, which will then be detected by a corresponding sensor.

With respect to the arrangement, the repeated variations could either be arranged at the lever or at a part of a self-contained lever assembly and the sensor could be arranged at the stationary part being adjacent to said lever, or the repeated variations are arranged at the stationary part being adjacent to said lever and the sensor is arranged at the lever or at a part of a self-contained lever assembly.

Furthermore, in this respect the repeated variations could be formed in such a way so as to be integral with the lever (or the part of a self-contained lever assembly) or with the stationary part being adjacent to said lever. Alternatively, the repeated variations could be formed by a separate element to be attached to the lever (or to the part of a self-contained lever assembly) or to the stationary part being adjacent to said lever. Such separate part could be a linear or arc-shaped metallic plate or stripe comprising the series of slots or teeth or the permanent magnets and will be attached to the respective part of these two components between which the path is to be formed.

For example, the stationary part being adjacent to said lever could be a part of a caliper, in case the brake monitoring device is used in disc brakes, or of an underframe part of a vehicle such as an anchor bracket, in case the brake monitoring device is used in drum brakes.

Brake assemblies most often comprise automatic slack adjusters for the compensation of the lining wear. The sensor for the brake monitoring device according to the invention first of all shall be mounted and configured to sense the relative travel between components in the brake assembly moving relative to each other at brake actuation only. However, as already mentioned above, the applied sensing principle does not require any reference points. Therefore, the sensor could be also mounted in a component of the brake assembly travelling during the brake actuation stroke as well as during lining wear compensation. One further advantage of the brake monitoring device according to the invention for that case is that no extra detection of the brake status is required, i.e. whether the brake is applied or not.

For the latter purpose it is advantageous to use means for generating a pulse of extra strength, e.g. double strength, somewhere near the end of the path in order to alert the driver or the superior system that the total travel has reached a value reflecting almost completely worn out linings of the brake pads or brake shoes. Accordingly, the path of the repeated variations comprises at least one additional irregular variation for determining a particular position of the actuation and/or release stroke, which position stands for a critical lining wear condition.

Furthermore, such irregular variation could be used as an indication of an unusual extra long stroke which will be safety hazardous. By means of such simple principle the superior control system does not have to exclusively rely on its software monitoring algorithms programmed for that event.

As becomes apparent from the above description, the brake monitoring device according to the invention generally proves to be very simple and cost efficient. Its functioning is reliable as no complicated algorithms have to be used for signal processing. The brake monitoring device can be used in connection with all kind of brakes and can be installed on all types of vehicles, from passenger cars to heavy road vehicles like trucks, buses and trailers. Due to the very easy sensing principle which indicates to a driver or a control system brake and release strokes beyond a predefined scale without the need to specify the exact quantity of it, installation of the brake monitoring device according to the invention on a large share of vehicles will contribute to a generally improved road safety.

Further, the invention refers to a drum brake which comprises a brake monitoring device as described before.

In drum brakes, a brake lever is mounted to a S-cam shaft with one end and is connected to a brake cylinder with its other free end, as this is well known in the art. Opposite to its end connected with a piston of a brake cylinder, the lever comprises a housing which receives an automatic slack adjuster which itself is connected by other components to the S-cam shaft. The automatic slack adjuster requires for its function a reference control signal. This reference is provided by a control arm which at one side is fixedly connected to a fix point on the vehicle underframe, normally by means of an anchor bracket, and which is pivotally connected to the brake lever at its other side.

The anchor bracket is used as a reference to measure the angular travel of the automatic slack adjuster of the drum brake during a brake application cycle in order to enable the automatic slack adjuster to adjust the brake lining, i.e. the brake shoes, to the drum clearance resulting from wear. At least one side of the housing is closed by a cover, usually made of specifically formed sheet metal.

According to one embodiment of the invention, in a drum brake, the cover of the housing comprises the path for the repeated variations, whereas the sensor is attached to the control arm.

As the cover is made of sheet metal, the invention has the advantage in that during manufacture of the sheet metal, by way of punching, stamping and bending etc., already the repeated variations in the form of slots or teeth could be provided at a corresponding location of the cover. Preferably, the path with the repeated variations is located as a half circle opposite to the free end of the brake lever. As the control arm is fixed to the underframe of the vehicle, it remains stationary, whereas the lever is rotating relative to it. Accordingly, the repeated variations of the cover of the housing of the lever will travel back and forth relative to the sensor attached to the control arm upon brake actuation and brake release movement of the lever. The sensor design is such that its housing can be clipped by corresponding fixation elements to the control arm. The housing may contain both the sensor and the magnet and, if applicable, corresponding electronics.

In one embodiment, the cover of the housing comprises a series of slots or teeth in the plane of its surface. However, it is also possible that the repeated variations are located on the arc-shaped underside of the lever opposite to its free end, i.e. perpendicular to the cover, whereby the arc-shaped path for that could be either provided integrally with the cover or it could be attached to the underside of the cast lever as a separately formed arc-shaped element. Ideally, this element comprises a series of recesses or slots. It is also possible that the repeated variations, such as teeth, are integral with the lever casting at the underside of it.

It is also possible that the sensor will be attached to the cover of the housing and that in turn the control arm comprises the path of the repeated variations. For that purpose, the sensor housing will be arranged above the control arm and the series of teeth or slots will be arranged as an arc on the upper half circle of the control arm.

For both cases it becomes apparent that the cover of the housing or the control arm integrally comprising the repeated variations can be easily and cost effectively manufactured in the common punching and stamping steps.

Accordingly, the invention also refers to a brake lever for drum brakes which comprises such path for repeated variations of a brake monitoring device.

Moreover, the invention refers to a disc brake which comprises a brake monitoring device as described before.

In disc brakes a lever, pivotally supported in a caliper activates at least one thrust element, which thrust element is displaceably guided in the caliper to be moved towards the brake disc upon brake actuation, as this is well known in the art. The thrust element could be a cross bar, a single tappet or similar.

According to the invention, the brake lever for disc brakes comprises the path of the repeated variations, ideally on a lateral surface of it. The sensor is located inside the caliper at a corresponding location in the area of the lever support.

As the brake lever usually is cast or forged as one piece, the repeated variations could be made during the casting or forging process as a series of dents. Alternatively, permanent magnets could be fixed to the lateral surface. On it, the repeated variations are forming an arc, which upon swivelling of the lever travels over the sensor which is stationary inside the caliper.

Accordingly, the invention also refers to a brake lever for disc brakes which comprises such path for repeated variations of a brake monitoring device.

The invention both for the application in drum brakes and in disc brakes is advantageous in several aspects.

The sensing principle of simply counting pulses and comparing the counted number of pulses with predetermined limits requires no sophisticated signal processing routines, so that inexpensive electronics can be used.

A major advantage is that the brake monitoring device will be arranged in the vicinity of the brake lever or directly at or on it, so that the sensor element used will be not exposed to high temperatures which occur near the brake drum and the brake disc, respectively.

For instance, in drum brakes, if the sensor element is located inside the brake drum, the sensor element with its cables would need a high temperature specification. If extremely high temperatures occur in the brake drum due to some kind of brake failure, there is the risk that the sensor element with its cables will be destroyed.

The same problems with respect to heat problems do come true for disc brakes in a similar way.

The measure according to the invention to arrange the brake monitoring device in the area of the lever, both for drum brakes and disc brakes, proves to be less complicated in terms of space requirements, assembly, cable fixation, inspection and overhaul.

Just as an example, when placing the sensor inside the brake drum, inspection and overhaul of the brake monitoring device with its sensor element requires the removal of the brake drum.

Both for applications in a disc brake and a drum brake the path of the repeated variations in a physical property can be arranged and located on a larger radius, due to less space constraints, which in turn enables a better sensing resolution, so that also less sophisticated and thus more inexpensive sensor elements can be used in this respect.

Moreover, when applying the repeated variations to the brake lever of a drum brake, it proves to be less costly to arrange the teeth or slots at the control arm or at the cover of the housing than at the end of the S-cam shaft, since these components are stamped and punched parts of sheet metal, so that the forming of the teeth or slots do no incur additional costs once the tooling has been made. Similar means at the end of the S-cam shaft would either call for a separate disc to be fixed to the S-cam shaft or for a more complicated and thus expensive machining or forging of the S-cam shaft.

One particular advantage of the brake monitoring device according to the invention is with respect to retrofitting. An existing brake lever can be very easily replaced with a lever equipped with a corresponding sensor element. On new vehicles of all types, the brake lever can be additionally equipped with the path of repeated variations at ignorable costs, e.g. by providing the toothed control arm, and then the additional sensor element only has to be easily mounted at a later stage on the vehicle assembly line.

### BRIEF DESCRIPTION OF THE DRAWINGS

Further advantages and embodiments do become apparent from the description of the different embodiments in connection with the enclosed drawings, in which

FIG. 1 shows a brake lever assembly for a drum brake with its main components according to the state of the art;

FIG. 2 shows a brake monitoring device according to the invention attached to a lever for a drum brake;

FIG. 3 shows a sensor according to the invention;

FIG. 4 shows the brake monitoring device according to the invention attached to a lever for a drum brake;

FIG. 5 shows the brake monitoring device according to the invention attached to a lever for a drum brake;

FIG. 6 shows the brake monitoring device according to the invention attached to a lever for a drum brake;

FIG. 7 shows the brake monitoring device according to the invention attached to a lever for a drum brake;

FIG. 8 shows a cross section of a disc brake principle; and

FIG. 9 shows the brake monitoring device according to the invention for a disc brake.

### DETAILED DESCRIPTION OF THE INVENTION

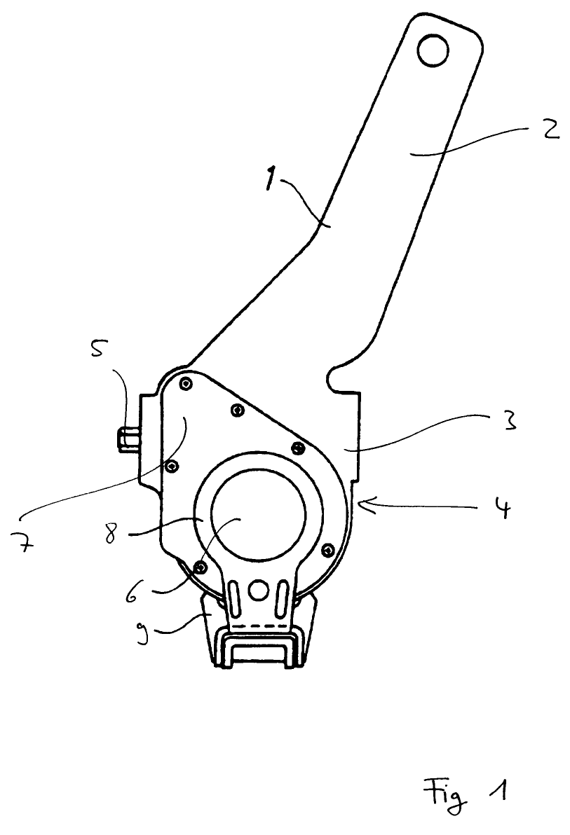

As an example, in FIG. 1 a self contained brake lever assembly for a drum brake is shown, as it is commonly used in the state of the art.

A lever 1 is made of cast iron and comprises an upper lever section 2 which attaches to a piston rod (not shown) of a hydraulic or pneumatic actuating cylinder. The upper lever section 2 descends into a lower lever section 3 with a housing 4 which receives an automatic slack adjuster mechanism 5 (partly shown by the end of a worm screw of said mechanism).

The slack adjuster mechanism 5 comprises, among other components, a worm screw and a worm wheel (not shown), the worm wheel being in connection with a S-cam shaft (not shown) via an opening 6 in the housing 4, as this is well known in the prior art. For further general information with respect to the configuration and function of such automatic slack adjusters it is e.g. referred to DE 195 34 854 A1 as previously mentioned.

The housing 4 is closed at least on one of its sides by a cover 7 made of sheet metal.

Furthermore, the automatic slack adjuster mechanism 5 of the lever 1 is connected with a control arm 8 which is attached to an adjacent underframe part, e.g. an anchor bracket 9, of the vehicle so as to provide a reference for the automatic slack adjuster mechanism 5.

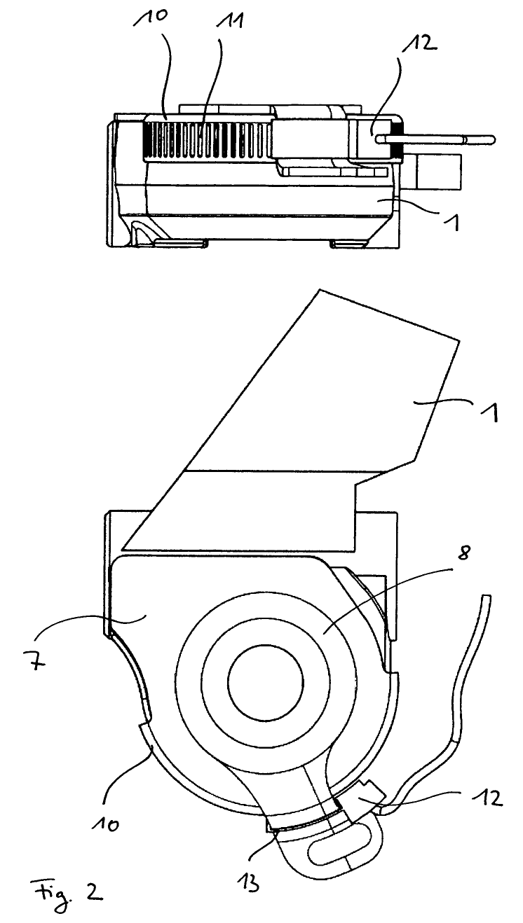

In FIG. 2 an exemplary embodiment of the brake monitoring device according to the invention is shown.

The cover 7 of housing 4 comprises at the end opposite to the upper lever section 2 an arc-shaped path 10. The path 10 is integral with the cover 7 at both sides of the housing 4.

The path 10 comprises repeated variations of a physical property, which is formed by geometric elements, namely a series of slots 11, which are equidistantly distributed around the arc-shaped path 10.

A sensor element 12 is fixed to the control arm 8 by means of a fixation element, e.g. such as a clip 13.

As it becomes apparent from the FIG. 2 the sensor element 12 remains stationary, while the path 10 with the slots 11 is travelling over the sensor element 12 upon rotation of the lever 1 during brake actuation or brake release.

According to the invention the sensor element 12 is configured to count the number of slots 11 thereby generating corresponding pulses.

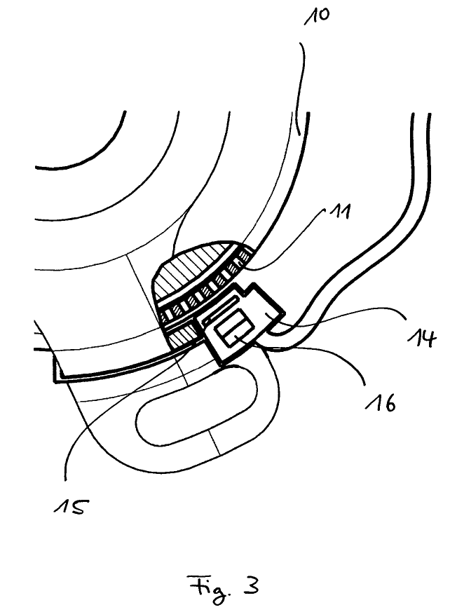

The sensor element 12 could be any kind of sensor which suits for the purpose of counting the number of slots 11. Most preferably, the sensor element 12 is a magnetic sensor, which could detect variations in the magnetic field resulting from the repeated variations of the slots 11, as this is shown in FIG. 3.

The sensor element 12 is formed by a self-contained housing 14 which housing 14 embeds a magnetic sensor 15, such as at least one Hall-element, and a magnet 16 located behind the sensor 15 opposite of path 10. The magnet 16 generates varying magnetic fields in accordance with the concentrated magnetic flux in the material portions between the slots 11 to be sensed by sensor 15, when the path 10 passes by.

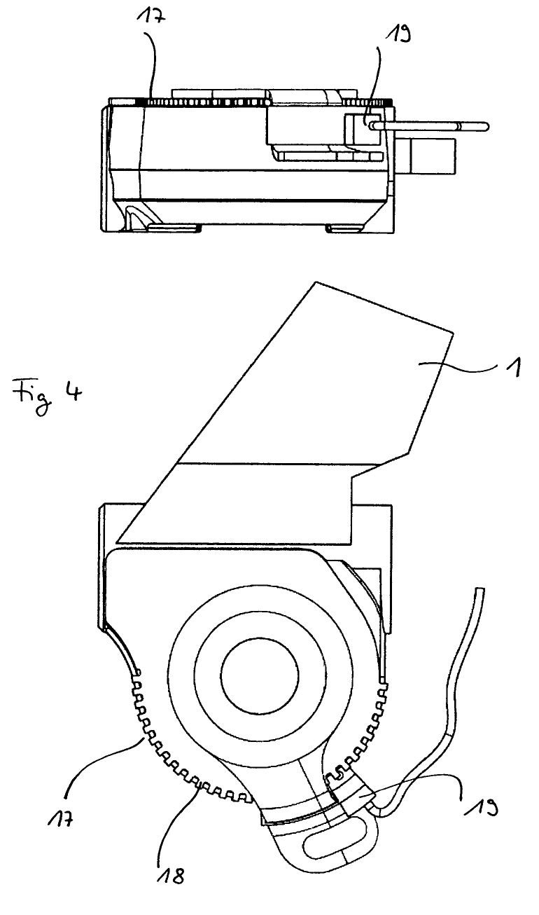

FIG. 4 shows an exemplary embodiment of the brake monitoring device according to the invention.

The cover 7 comprises opposite to the upper lever section 2 a path 17 which is formed by an arc-shaped series of teeth 18. The sensor element 19 is arranged at the control arm 8 laterally to the arc-shaped path 17 so that the teeth 18 pass by upon rotation of the lever 1 during brake actuation and brake release. Also here, the sensor element 19 is configured to generate and count pulses in accordance with the series of teeth 18.

The advantage of the previously described embodiments can be seen in an integrated manufacturing process. The cover 7 is made from sheet metal by way of punching, stamping and bending. Therefore, the provision of the path 10 with the slots 11 or the path 17 with teeth 18 can be already foreseen in the punching and stamping process for the cover 7, by additional bending, if required.

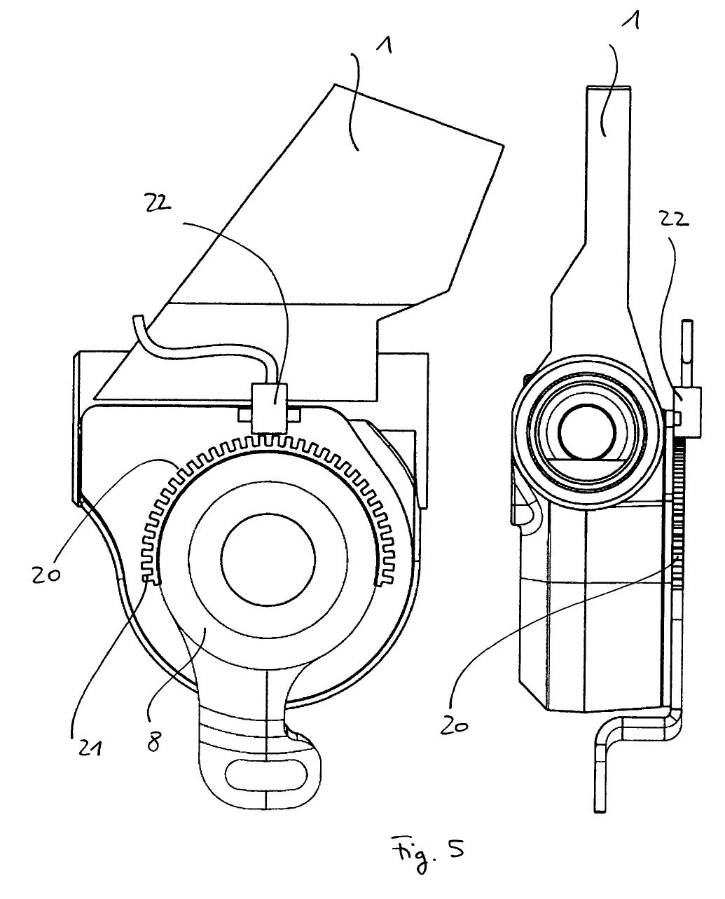

FIG. 5 shows an exemplary embodiment of the brake monitoring device according to the invention, in which the moving component with respect to the relative movement is put to the sensor side.

The control arm 8 comprises on its upper part facing the upper lever section 2 an arc-shaped path 20 with a series of teeth 21. Accordingly, the sensor element 22 has to be attached in a stationary manner to the housing 4 directly or to the cover 7 of the housing 4 of the lever 1. Upon rotation of the lever 1 during brake actuation and brake release the sensor element 22 travels over the stationary path 20 of the control arm 8.

In the present embodiment, the path 20 is either integral with the control arm 8 or could be made as a separate arc element to be attached to the control arm 8. This element could be also made from sheet metal by punching and stamping and could be welded or clued to the control arm 9.

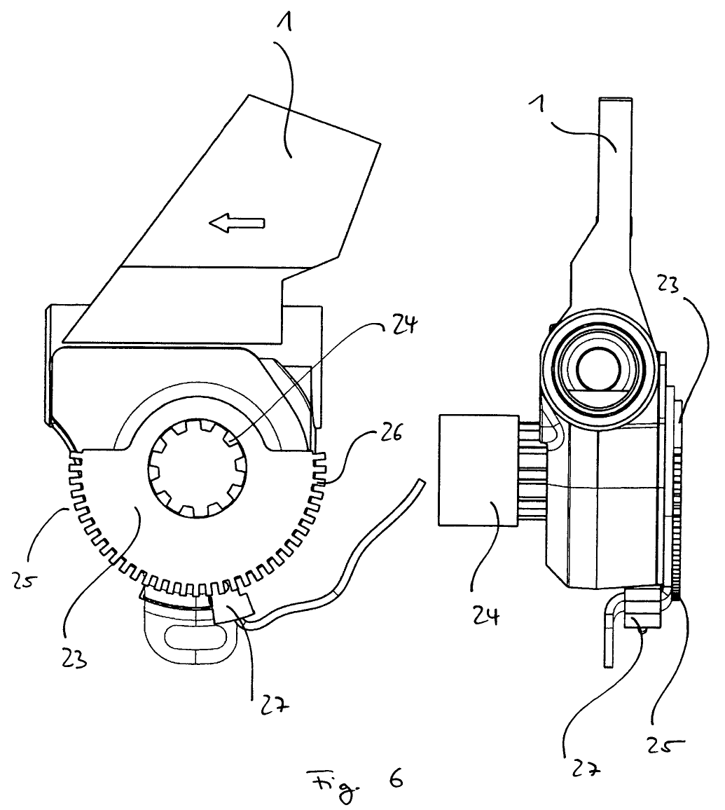

FIG. 6 shows an exemplary embodiment of the brake monitoring device according to the invention in which the path for the repeated variations of the physical property is provided as a separate element.

A plate 23 of sheet metal is rotatably fixed to an actuating camshaft 24 for the S-cam shaft, so as to rotate with the lever 1 upon brake actuation and brake release.

The plate 23 comprises a path 25 with a series of teeth 26. A sensor element 27 is attached to the control arm 8, accordingly.

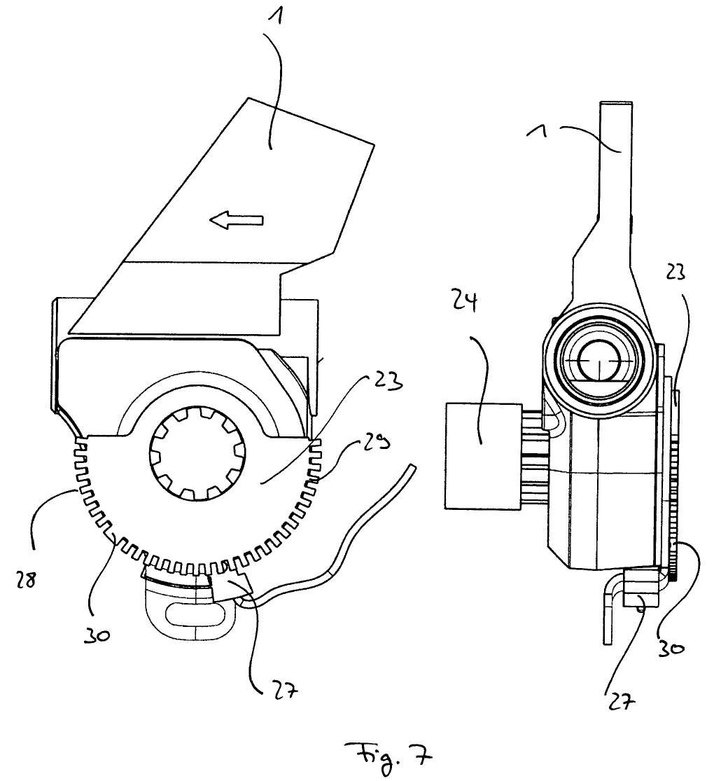

FIG. 7 shows an embodiment of the brake monitoring device according to the invention with an alternative configuration for the path of the repeated variations of the physical property.

The path 28 with the series of teeth 29 of the separate plate 23 comprises at a certain position an irregular variation 30, which corresponds to a tooth of double width.

The position for the extra broad tooth 30 is predefined and determines a position along the path 28 in which the rotation of the lever 1 reaches a critical value for the brake actuation or release stroke, e.g. with respect to lining wear.

When this feature is combined with an arrangement according to FIG. 6, the extra broad tooth 30 determines a position of critical value for the lining wear.

Accordingly, the irregular tooth 30 will provide a pulse of different strength so that the control unit realizes that the critical position has been reached and that service actions are required immediately.

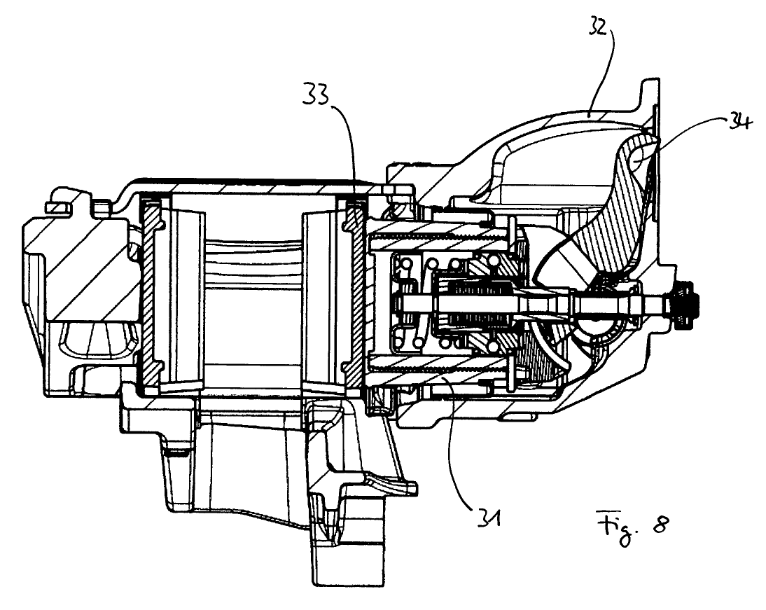

In FIG. 8 as an example a disc brake in cross section is shown, as this is known in the state of the art.

The disc brake comprises an actuating mechanism, as this is well known in prior art, containing a thrust element 31 displaceably guided in a caliper 32 forcing a brake pad 33 towards a brake disc (not shown) for brake engagement. The thrust element 31 is activated by a lever 34 which is rotatably supported in the rear end of the caliper 32.

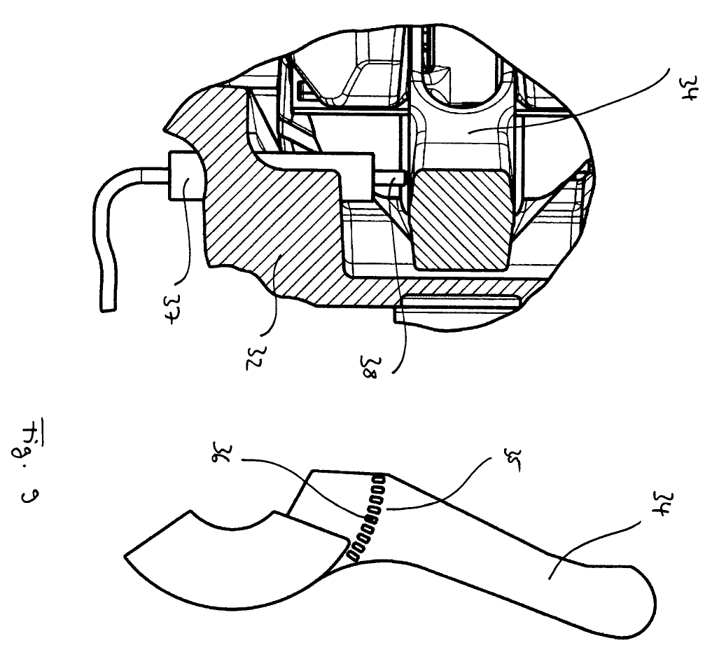

According to the invention, as can be seen in FIG. 9, the lever 34 comprises on its lateral side, i.e. parallel to the swivelling direction of the lever 34, an arc-shaped path 35 of repeated variations. These repeated variations could be formed as dents 36 in the surface of the lever 34, which can be formed during the casting of forging process.

A sensor element 37 is arranged inside the housing of the caliper 32 through an opening at a corresponding position so that the path 35 travels along a sensor head 38 of the sensor element 37 upon brake actuation and brake release. Also in this embodiment, the sensor element 37 is located substantially opposite of the heat intensive region near the brake disc.

1. A brake monitoring device for detecting a value indicative of the actuation stroke and/or release stroke of a thrust element of a brake actuating mechanism, the thrust element being actuated by a lever of said brake actuating mechanism, comprising a sensor for sensing variations in a physical property of at least one part of said brake actuating mechanism, whereby the sensor and said part of the brake actuating mechanism are arranged so that by the relative movement between said part of the brake actuating mechanism and the sensor repeated variations in said physical property along a path of said relative movement are sensed, characterized in that said path of repeated variations in physical property is formed along one of the lever and a stationary part being adjacent to said lever.

2. The brake monitoring device according to claim 1, wherein the physical property for the repeated variations is selected from magnetic field, electric resistance, electric capacitance, electric inductance and/or surface structure.

3. The brake monitoring device according to claim 1, wherein said path comprises repeated variations in geometry.

4. The brake monitoring device according to claim 3, wherein the repeated variations in geometry are formed by recesses.

5. The brake monitoring device according to claim 3, wherein the repeated variations in geometry are formed by a series of teeth.

6. The brake monitoring device according to claim 4, wherein at least one magnet is arranged in the vicinity of the repeated variations so as to create a varying strength of a magnetic field for said repeated variations.

7. The brake monitoring device according to claim 1, wherein said path comprises a series of permanent magnets.

8. The brake monitoring device according to claim 1, wherein the repeated variations are arranged on the lever and the sensor is arranged on the stationary part being adjacent to said lever.

9. The brake monitoring device according to claim 1, wherein the repeated variations are arranged on the stationary part being adjacent to said lever and the sensor is arranged on the lever.

10. The brake monitoring device according to claim 8, wherein said repeated variations are formed integral with the lever or with the stationary part being adjacent to said lever.

11. The brake monitoring device according to claim 8, wherein said repeated variations are formed by a separate element to be attached to the lever or to the stationary part being adjacent to said lever.

12. The brake monitoring device according to claim 1, wherein the stationary part being adjacent to said lever is a part of a self-contained brake lever assembly, of a caliper or of an underframe part of a vehicle.

13. The brake monitoring device according to claim 1, wherein the path of the repeated variations comprises at least one additional irregular variation for determining a particular position of the actuation and/or release stroke.

14. The brake monitoring device according to claim 1, wherein the path is an arc-shaped path.

15. A drum brake comprising a brake monitoring device according to claim 1.

16. The drum brake according to claim 15, the drum brake comprising a lever with a housing for receiving an adjuster mechanism in connection with a S-cam shaft and a control arm for said adjuster mechanism, characterized in that the path is arranged at the cover of the housing opposite to a free end of the lever and the sensor is attached to the control arm.

17. The drum brake according to claim 15, the drum brake comprising a lever with a housing for receiving an adjuster mechanism in connection with a S-cam shaft and a control arm for said adjuster mechanism, characterized in that the path is arranged at the control arm and the sensor is attached to the cover of the housing.

18. A control arm for an adjuster mechanism of a brake actuating mechanism of a drum brake, the control arm comprising a path of repeated variations in a physical property.

19. The control arm according to claim 18, wherein the control arm is made from sheet metal and in which the repeated variations are formed by recesses or a series of teeth being integral with the sheet metal.

20. A cover for a housing of a lever of a brake actuating mechanism of a drum brake, the cover comprising a path of repeated variations in a physical property.

21. The cover according to claim 20, wherein the cover is made from sheet metal and in which the repeated variations are formed by recesses or a series of teeth being integral with the sheet metal.

22. A brake lever of a brake actuating mechanism for a drum brake comprising a housing for receiving an adjuster mechanism in connection with a S-cam shaft and a control arm for said adjuster mechanism, characterized in that the lever comprises a path of repeated variations in a physical property.

23. The brake lever according to claim 22, wherein a cover of the housing comprises said path of repeated variations in a physical property.

24. The brake lever according to claim 22, wherein the control arm comprises said path of repeated variations in a physical property.

25. A disc brake comprising a brake monitoring device according to claim 1.

26. The disc brake according to claim 25, the disc brake comprising a brake actuating mechanism with a lever, characterized in that the repeated variations are arranged on a lateral surface of the lever.

27. The brake lever of a brake actuating mechanism for a disc brake, characterized in that the lever comprises of path of repeated variations in a physical property.

28. The brake lever according to claim 27, wherein said repeated variations are arranged on a lateral surface of the lever.

29. The brake lever according to claim 28, wherein lever is made of cast iron or forged steel and said repeated variations are formed as dents being integral with the cast iron or with the forged steel.
